(19) United States
(12) Patent Application Publication
(10) Pub. No.: US 2001/0055992 A1
(43) Pub. Date: Dec. 27, 2001

(54) TOOTHCOUPLING WITH FACE GEAR TOOTHING

(76) Inventor: AUGUSTINUS F.H. BASSTEIN, PRINSENBEEK (NL)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/417,450

(22) Filed: Oct. 13, 1999

Related U.S. Application Data
(63) Continuation of application No. PCT/NL98/00211, filed on Apr. 14, 1998.

(30) Foreign Application Priority Data
Apr. 14, 1997 (NL) 1005805

(51) Int. Cl. F16D 3/18; F16D 3/44

(52) U.S. Cl. 464/157

(57) ABSTRACT

The invention relates to a tooth coupling, in which the toothing is a face gear toothing. The special shape of the face gear teeth achieves the effect where the active tooth flank portions of the face gear toothing always lie against one another, with the result that the permissible loading and the alignment are improved.

The invention also relates to a method for making the coupling toothing with a hob, a negative width curvature being formed in the toothing, with the result that the contact pressure is lower. The inventive method is easy to use on a universal gear cutting machine.

This is a continuation application of PCT/NL98/00211 filed Apr. 14, 1998.

### FIELD OF INVENTION

The invention relates to a tooth coupling for coupling the rotation of two shafts which lie in line with one another.

### BACKGROUND OF THE INVENTION

The handbook “Verzahnwerkzeuge”, edited by Lorenz, discloses on page 61, a tooth coupling for coupling the rotation of two shafts which lie in line with one another, comprising two coupling halves, each having a toothing which is directed towards the other coupling half and can mesh with the other toothing, which toothing is a face gear toothing, the active tooth flank portions of which are derived from a cylindrical pinion with involute toothing, and are delimited at the bottom by a transition to a root fillet and at the top are delimited by a tooth tip. On studying the known tooth coupling with face gear toothing, it is found that, if the coupling halves are pressed completely against one another, the teeth stand on the internal diameter, the teeth tips bearing against the tooth root. If the coupling halves are pushed apart slightly, for example under the influence of load, the tooth tip begins to bear against the tooth flank. Consequently, the bearing location is also dependent on the top surface of the face gear, with the result that the accuracy of alignment of the two coupling halves is adversely affected.

A comparable tooth coupling is also known, inter alia, from U.S. Pat. No. 4,307,797, in which a coupling with coupling halves is described, which halves are provided with a spiral toothing which is made by means of hobs. The toothing of one coupling half is the mirror image of the toothing of the other coupling half, with the result that the flanks are always parallel to one another. A drawback of this known tooth coupling is that, if the coupling halves are positioned slightly apart under the influence of load or as a result of tolerances during production, then the flanks are no longer parallel to one another, and the flanks then come to bear against one another only on the external diameter. This edge loading leads to higher surface pressure, with the result that only a low load is permissible for the coupling.

### SUMMARY OF THE INVENTION

The object of the invention is to improve this situation. This object is achieved according to the invention in that the toothing the toothing having a central plane which is parallel to the tooth root of the toothing and is tangent on a line (B) of the tooth flank which has an equal distance from the center of a tooth and an adjoining tooth space, the tooth tip being designed such that for each radius of the toothing the distance (a) from the tooth tip to the central plane is less than the distance (b) from the central plane to the transition between the tooth flank and the root fillet.

The result is that the tip of one coupling half does not come into contact with the root of the other coupling half, with the result that the contact between the coupling halves occurs between the accurately machined toothing flanks and with the result that the alignment of the coupling halves is independent of manufacturing errors in the tip height and deviations in the root fillet.

According to a further improvement, the toothing of one coupling half is provided with a negative width curvature, in such a manner that the radius of curvature of the intersection between a face gear tooth and a plane parallel to the toothing, such as for example the central plane, is greater than the radius of curvature of a toothing without width curvature.

As a result, the radius of curvature with which the two coupling halves bear against one another is increased, thus increasing the load-bearing capacity.

According to a further improvement, the geometry of the cylindrical pinions from which the face gear toothings of the coupling halves are derived is different.

This also increases the radius of curvature with which the two coupling halves bear against one another.

According to a further improvement, the deepest point of the tooth root between the internal diameter and the external diameter of the toothing lies at a deeper level than at the location of the internal and/or external diameter.

As a result, the width curvature is formed simultaneously on both flanks in a simple manner.

The invention also relates to a method for making the toothing in a coupling half of a tooth coupling by machining the coupling half with a hob in a gear cutting machine.

A method of this kind is known, the hob generally being moved along the workpiece in the tooth direction.

According to the invention, the hob is suitable for machining face gears and the workpiece is machined by moving the hob substantially at right angles to the toothing during machining.

As a result, the machining time can be very short, while at the same time a negative width curvature is formed which results from the radius of the hob.

The invention also relates to a method for making the toothing in a coupling half of a tooth coupling by machining the coupling half with a hob in a gear cutting machine, the workpiece being machined by moving the hob along the workpiece in the direction of the toothingm wherein the hob is suitable for machining face gears and during machining in the tooth direction is successively moved towards and away from the workpiece in order to form a negative width curvature.

As a result, a negative width curvature is obtained in a simple manner.

### BRIEF DESCRIPTION OF THE DRAWINGS

The invention is explained below with reference to a drawing of an exemplary embodiment of the invention, in which:

FIG. 1 shows a section through a changeable tooth coupling,

FIG. 2 shows a side view of a face gear tooth of a coupling half,

FIG. 3 shows a number of views of the face gear tooth in accordance with FIG. 2,

FIG. 4 shows a diagrammatic plan view of two coupling halves which are in full engagement with one another,

FIG. 5 shows section V-V of FIG. 4,

FIG. 6 shows a diagrammatic plan view of two coupling halves which are partially in engagement with one another,

FIG. 7 shows section VII-VII of FIG. 6, and

FIG. 8 shows a side view of a face gear tooth of a coupling half, which has a negative width curvature.

### DETAILED DESCRIPTION OF A PREFERRED EMBODIMENT

In the various figures, corresponding components are as far as possible always provided with the same reference numerals.

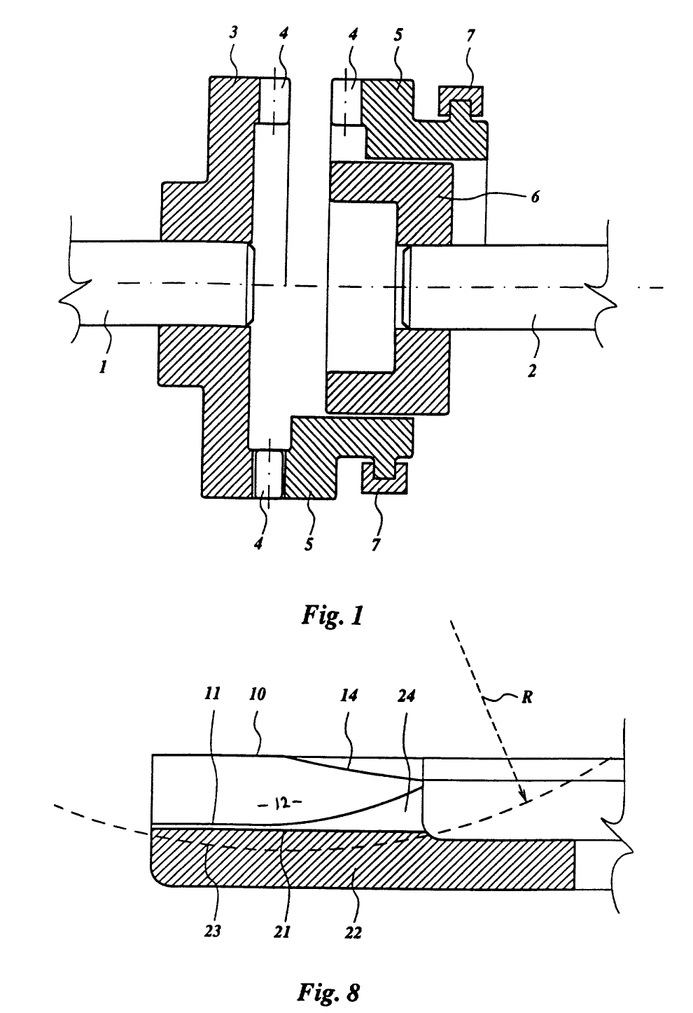

FIG. 1 shows an embodiment of a changeable tooth coupling. A first coupling half 3 is arranged on a first shaft 1, and a second coupling half 5 can be shifted in the axial direction using a switching ring 7 attached to a body 6 which is attached to a second shaft 2. The first coupling half 3 and the second coupling half 5 are each provided with a coupling toothing 4 which mesh with one another and to this end have an identical number of teeth.

A tooth coupling of this kind, an example of which is shown here, is generally designed with a Hirth toothing, in which there are mechanically or electrically changeable couplings, as well as couplings in which the coupling halves 3 and 5 are pulled towards one another by means of bolts or are pressed against one another under spring loading, so that a protection against overloading is also achieved. In the example illustrated, the toothing 4 is at right angles to the axis of rotation of the tooth coupling, but designs are also known in which this angle differs from a right angle.

Couplings of this kind are used for coupling the rotation of the two shafts, and for centring the two shafts with respect to one another. To this end, it is important that the toothing of the coupling half be made accurately and that when the teeth are in full engagement with one another both flanks of all the teeth of one coupling half mesh with both flanks of all the teeth of the other coupling half.

In order to be able to satisfy the abovementioned requirements, according to the invention the toothing 4 is designed as a face gear toothing, that is to say a toothing which can interact with a cylindrical involute pinion. The shape of this toothing is completely defined by the geometry of the pinion from which the face gear toothing is derived. The face gear toothing may, for example, be produced using a hobbing process with a hob in accordance with EP-0,494,221, EP-0,559,798 or EP-0,330,289.

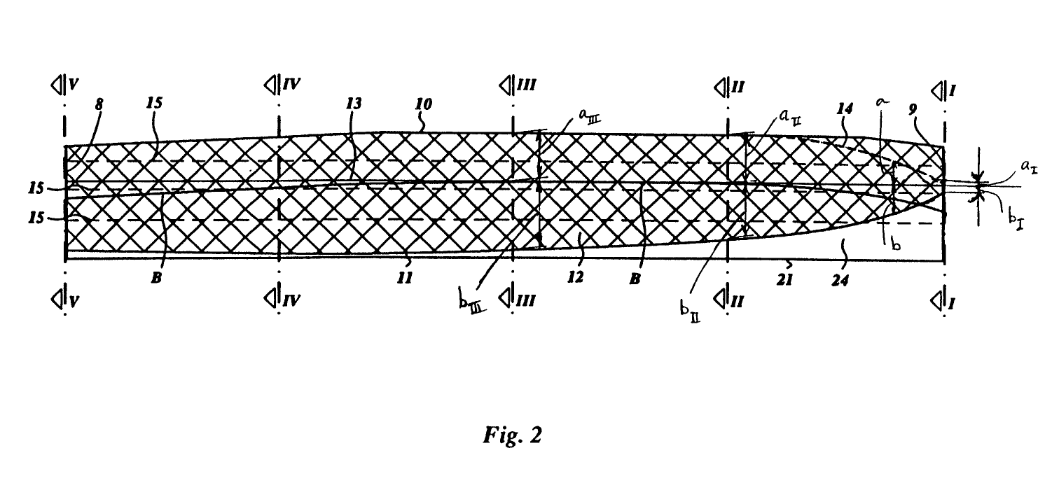

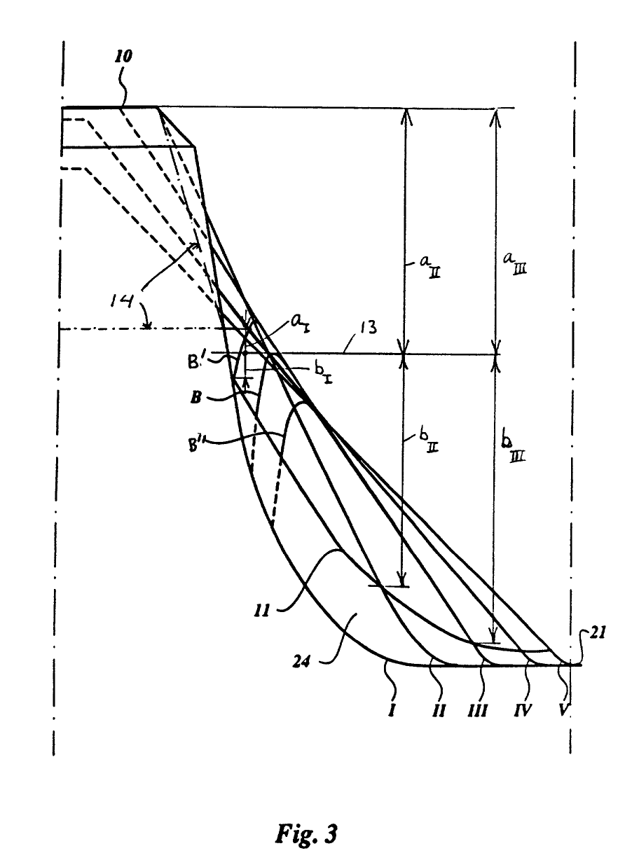

FIG. 2 shows a side view of a face gear tooth, while FIG. 3 shows the views I-V of the same tooth.

In FIG. 2, 9 denotes the internal diameter of the toothing and 8 denotes the external diameter. The active tooth flank 12 (hatched in crossed lines) is dependent on the form of the involute tooth flank of the pinion from which the toothing is derived, and in FIG. 2, 12 denotes the usual active tooth flank in the case of interaction between a pinion and a face gear. At the top, the active tooth flank 12 is delimited by a tooth tip 10, and at the bottom it is delimited by a transition 11 from the tooth flank to a root fillet 24. The root fillet 24 has a tooth root 21 as its deepest part, the depth of the tooth root 21 being defined primarily by the diameter of the pinion from which the toothing is derived and the shape of the tool used. FIG. 2 also shows surface contour lines 15 which are at a constant distance from the tooth root 21.

FIG. 3 shows the view and intersections with the planes I-V of the tooth of FIG. 2, the changing angle of inclination of the tooth flank being visible; this figure shows that the shape of an intersection I-V of the active tooth flank 12 is a substantially straight line. A dividing plane which lies at an equal distance from the centre of a tooth and the centre of a tooth space and which is perpendicular to a plane through the tooth roots 21 intersects the active tooth flank 12 along a line B. The position of the flank with respect to the dividing plane can vary with the thickness of the face gear tooth, which is dependent on the geometry of the pinion, such as for example the W-dimension thereof. Depending on this W-dimension, the centre of tooth and tooth space can intersect the active tooth flank 12 along lines B, B′ or B″, which can be calculated.

In FIGS. 2 and 3, the line of intersection between tooth flank 12 and the dividing plane is indicated by the line B, a central plane 13 parallel to a plane through the tooth roots 21 being shown, which central plane 13 is tangent on the highest point on line B. In this case, a is the distance between the central plane 13 and an adapted tooth tip 14, which is denoted by dot-dashed lines and is adapted in such a way that this distance a is less than the distance b from the central plane 13 to the transition 11 from the active tooth flank 12 to the root fillet 24. At the location of the cross-sections I, II and III, a and b are respectively denoted aI, bI; aII, bII and AIII, bIII. As a result of the adapted tooth tip 14, when the toothings of the two coupling halves are in full engagement with one another, the tooth tip 10 or 14 never comes into contact with the root fillet 24, thus precluding alignment errors and excessive pressures.

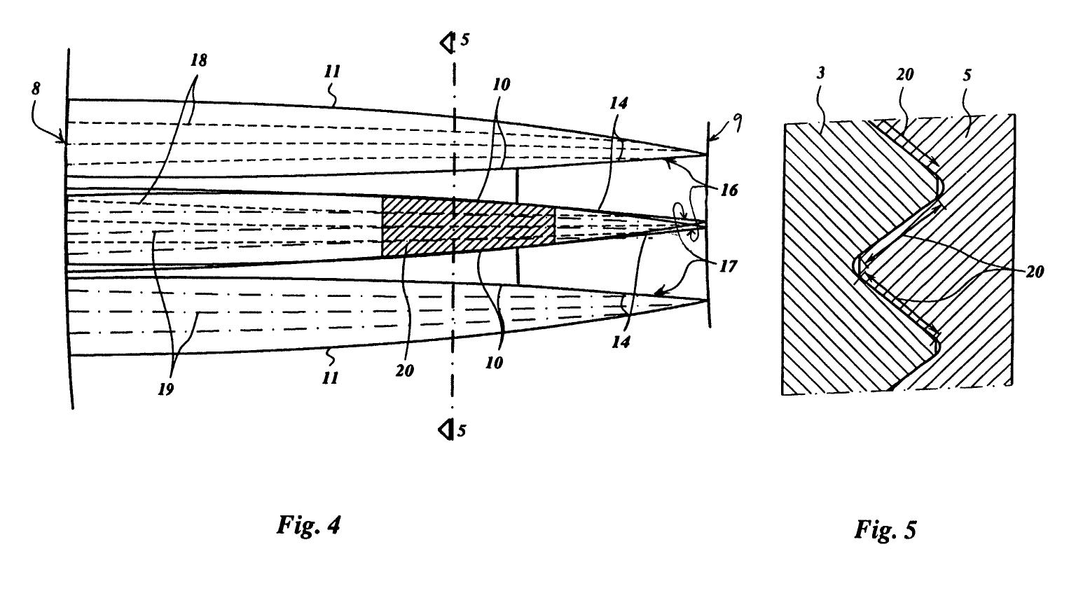

FIG. 4 shows a plan view of the outlines of the active tooth flank portions 16 together with surface contour lines 18 of the first coupling half 3, as well as the outlines of the active tooth flank portions 17, together with surface contour lines 19 of the second coupling half 5. These outlines are delimited by the tooth tip 10 and in part tooth tip 14, the root fillet 11 and the external diameter 8. The two coupling halves mesh with one another in such a manner that both active tooth flank portions 16 of the first coupling half 3 are in contact with both active flank portions 17 of the second coupling half 5. Both tooth flanks 16 and 17 are in contact with one another for example in a contact region 20, and it is shown with the aid of the surface contour lines 18 and 19 that the surfaces are slightly rounded with a large radius of curvature and are in contact with one another over the full height. As a result of this large radius of curvature, there is always a low surface pressure, even if the coupling halves are rotated slightly with respect to one another, for example if they are not fully in engagement with one another. FIG. 5 shows a cross-section of the meshing situation in accordance with FIG. 4.

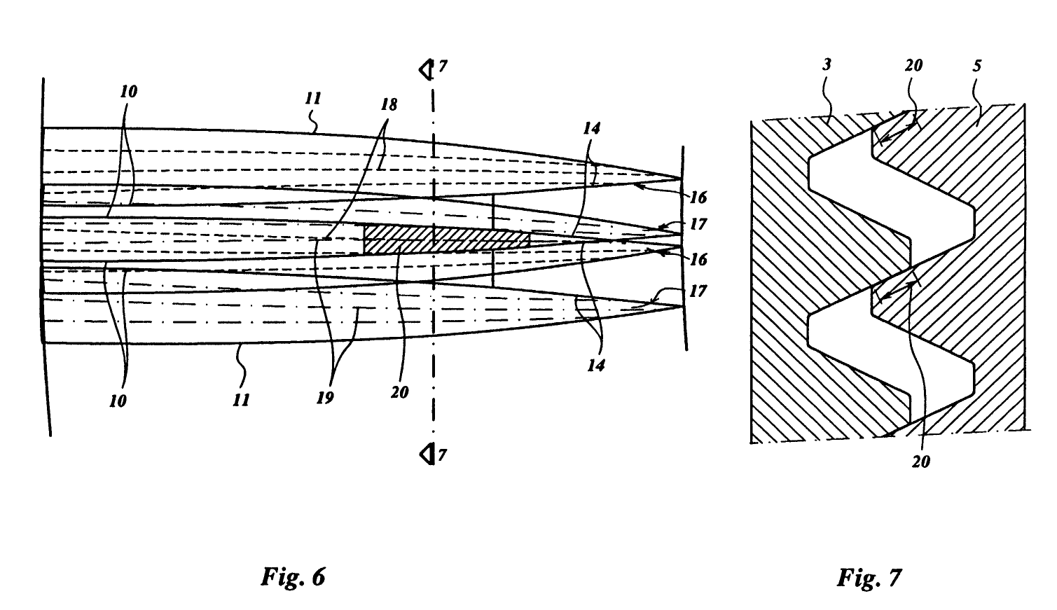

The plan view shown in FIG. 6 corresponds to the plan view in accordance with FIG. 4, except that the coupling halves 3 and 5 are not fully in engagement with one another, as shown in the cross-section in FIG. 7. The contact region 20 is clearly less high. From the path of the surface contour lines 18 and 19 it can also be seen that in this situation a rounded tooth flank still always rests against a rounded tooth flank, with the result that the contact pressure remains as low as possible.

The contact pressure can be reduced further by selecting the geometry of the pinions from which the face gear toothing is derived, for example by selecting different numbers of teeth of the pinions associated with the different face gears and by optimally selecting the tooth profile displacements, numbers of teeth of the pinions and numbers of teeth of the face gears. As a result, it is possible to select the resulting radius of curvature, which in accordance with Hertz's theory is the sum of the radii of curvature of both active tooth flank portions 12, to be as large as possible, so that the surface pressure (Hertz pressure) occurring is as low as possible. It is also possible in this way to optimize the position of the contact region 20.

By designing the toothing of one or both coupling halves 3 and 5 with a negative width curvature, the radius of curvature, and hence the load-bearing capacity, can be increased still further. FIG. 8 shows a coupling half 22 in which it is diagrammatically illustrated how the shape of the tooth root 21 can be adapted so that negative width curvature is produced in both tooth flanks of a tooth. In this case, the tooth root 21 is adapted to form a recessed tooth root 23 and the tooth flank 12 is adapted accordingly. If the coupling half is made using a hob having a radius R, this recessed tooth root 23 is produced if the hob is moved into the workpiece perpendicular to the toothing, a process which allows very short machining times. In addition, this machining can take place on a generally available universal gear cutting machine, since the movements of the hob correspond to the movements which are used when machining cylindrical gear wheels.

The width curvature which is produced as a result of the above-described method can be so strongly negative that the result could even be concave tooth flanks. This can be prevented by correctly selecting the geometry of the pinions and the numbers of teeth of the face gear toothing.

The coupling halves can be made by machining using a hob, as described above, but it is also possible to obtain the coupling toothing by non-cutting operations, such as forging, injection-moulding plastic, for example, or using powder metallurgy, in which case metal in powder form is compressed in a mould. The moulds which can be used for these processes are made using tools which have been machined in the manner described above. By machining in the manner described above, it is also possible to make an electrode with which the desired shape can be produced in the moulds using spark erosion.

What is claimed is:

1. A tooth coupling for coupling the rotation of two shafts which lie in line with one another, comprising two coupling halves, each having a toothing which is directed towards the other coupling half and can mesh with the other toothing, which toothing is a face gear toothing, the active tooth flank portions of which are derived from a cylindrical pinion with involute toothing, and are delimited at the bottom by a transition to a root fillet and at the top are delimited by a tooth tip, the toothing having a central plane which is parallel to the tooth root of the toothing and is tangent on a line (B) of the tooth flank which has an equal distance from the center of a tooth and an adjoining tooth space, the tooth tip being designed such that for each radius of the toothing the distance (a) from the tooth tip to the central plane is less than the distance (b) from the central plane to the transition between the tooth flank and the root fillet.

2. The tooth coupling of claim 1, wherein the toothing of one coupling half is provided with a negative width curvature, in such a manner that the radius of curvature of the intersection between a face gear tooth and a plane parallel to the toothing, such as for example the central plane, is greater than the radius of curvature of a toothing without width curvature.

3. The tooth coupling of claim 1, wherein the geometry of the cylindrical pinions from which the face gear toothings of the coupling halves are derived is different.

4. The tooth coupling claim 2, wherein the deepest point of the tooth root between the internal diameter and the external diameter of the toothing lies at a deeper level than at the location of the internal and/or external diameter.

5. The tooth coupling of claim 3, wherein the deepest point of the tooth root between the internal diameter and the external diameter of the toothing lies at a deeper level than at the location of the internal and/or external diameter.

6. A method for making the toothing for a coupling half of a tooth coupling by machining the coupling half with a hob in a gear cutting machine, the hob being suitable for machining face gears and the workpiece being machined by moving the hob substantially at right angles to the toothing during machining.

7. A method for making the toothing for a coupling half of a tooth coupling by machining the coupling half with a hob in a gear cutting machine, the workpiece being machined by moving the hob along the workpiece in the direction of the toothing, the hob being suitable for machining face gears and during machining in the tooth direction is successively moved towards and away from the workpiece in order to form a negative width curvature.
